(19) United States
(12) Patent Application Publication
(10) Pub. No.: US 2016/0286005 A1
(43) Pub. Date: Sep. 29, 2016

(54) BROWSER SYSTEM AND METHOD

(71) Applicant: Cocoon Data Holdings Limited, Sydney (AU)

(72) Inventor: Craig Bruce, Elanora Heights (AU)

(21) Appl. No.: 14/922,195

(22) Filed: Oct. 26, 2015

(30) Foreign Application Priority Data
Mar. 25, 2015 (AU) 2015201536

(51) Int. Cl. H04L 29/06; G06F 9/455; G06F 21/60; H04L 29/08

(52) U.S. Cl. CPC H04L 67/42; H04L 67/025; H04L 67/10; G06F 9/45529; G06F 21/602

(57) ABSTRACT

A computer-implementable method and system for controlling data processing by a browser application executable on a client device are disclosed. The method comprises receiving instructions at the client device to process data, determining at least one processing parameter associated with processing of the data by the browser application, and determining whether the instructed processing is to be executed by the browser application based upon the determined at least one processing parameter. The method initiates at least one browser sub-process to process the data where processing is determined is to be executed by the browser application. The method instructs a server application executable on a server computer in communication with the client device to process the data where processing is determined not to be executed by the browser application. The method further comprises storing the processed data at one of the client device and the server computer.

### REFERENCE TO RELATED PATENT APPLICATIONS

This application claims the benefit under 35 U.S.C. §119 of the filing date of Australian Patent Application No. 2015201536, filed Mar. 25, 2015, hereby incorporated by reference in its entirety as if fully set forth herein.

### TECHNICAL FIELD

The present invention relates to processing of data using a browser application.

### BACKGROUND

Traditionally, computation-intensive processing of data has been performed in server machines and using server applications.

The ability to process data within a web browser application, typically in communication with a server application, has been considered in recent years due to advancement of web browser application capabilities and corresponding supporting standards, such as HTML5. However, browser applications differ widely between versions, operating systems, and the types of electronic devices within which they operate. Incompatibilities between browser applications across different operating systems and devices often result in poor performance and complexity in browser-based data processing systems. Many people attempting to use such systems have experienced frustration or difficulties on completing required data processing. For example, in some instances, a user may not be able to log out of a browser application until the required processing is complete, but this may take some time. In other instances, the browser application may become unresponsive and require forced termination.

### SUMMARY

According to a first aspect of the present disclosure there is provided a method for controlling data processing by a browser application executable on a client device, the method comprising: receiving instructions at the client device to process data; determining at least one processing parameter associated with processing of the data by the browser application; determining whether the instructed processing is to be executed by the browser application based upon the determined at least one processing parameter; initiating at least one browser sub-process to process the data where processing is determined is to be executed by the browser application; instructing a server application executable on a server computer in communication with the client device to process the data where processing is determined not to be executed by the browser application; and storing the processed data at one of the client device and the server computer.

A further aspect of the present disclosure provides a system for controlling data processing by a browser application, the system comprising: a server computer; and a client device in communication with the server computer; the browser application being executable on the client device, the client device being configured to: receive instructions to process data; determine at least one processing parameter associated with processing of the data by the browser application; determine whether the instructed processing is to be executed by the browser application based upon the determined at least one processing parameter; initiate at least one browser sub-process to process the data where processing is determined is to be executed by the browser application; instruct the server application executable on a server computer to process the data where processing is determined not to be executed by the browser application; and store the processed data on one of the client device and the server computer.

A further aspect of the present disclosure provides a computer-implementable method for controlling data cryptographic processing by a browser application executable on a client device, the method comprising: receiving instructions at the client device to perform cryptographic processing on data; determining at least one processing parameter associated with cryptographic processing of the data by the browser application; determining whether the instructed cryptographic processing is to be executed by the browser application based upon the determined at least one processing parameter; obtaining a cryptographic key and initiating at least one browser sub-process to conduct the cryptographic processing of the data where cryptographic processing is determined is to be executed by the browser application; instructing a server application executable on a server computer in communication with the client device to retrieve a cryptographic key and conduct the cryptographic processing of the data where cryptographic processing is determined not to be executed by the browser application; and storing the processed data at one of the client device and the server computer.

Other aspects are also disclosed.

### BRIEF DESCRIPTION OF THE DRAWINGS

At least one embodiment of the present invention will now be described with reference to drawings, in which:

FIG. 1A shows a schematic block diagram representation of a browser system;

FIG. 1B is a schematic block diagram of a general purpose computer system upon which arrangements described may be practiced;

FIG. 2 is a high level flow diagram of a browser method;

FIG. 3 is a flow diagram of a method for encrypting a file;

FIG. 4 is a flow diagram of a method for decrypting a file; and

FIGS. 5A-5D show data flows for a number of scenarios in the browser system.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

The present application relates to data processing, particularly heavy computational processing, and methods of performing the same effectively via a browser application. In many situations, it is desirable to perform computational work on the client side of a server application, thus making each client responsible for their own data processing rather having a single server response for many computations on behalf of numerous clients. Otherwise, the server can experience high levels of traffic or bottleneck, and clients may accordingly experience long waiting times for receiving process data. Further, high demand and/or long server-side processing times may require IT departments to purchase expensive hardware to keep up with the client processing requests.

The description hereafter provides examples in relation to cryptographic processing (encryption and decryption) in a browser application. However, the solution described herein is not restricted to cryptography, but equally applies to any type of heavy computational processing. Examples may include, image processing, video processing, document file format conversion, compression, or any other type of computation-intensive processing.

### System Overview

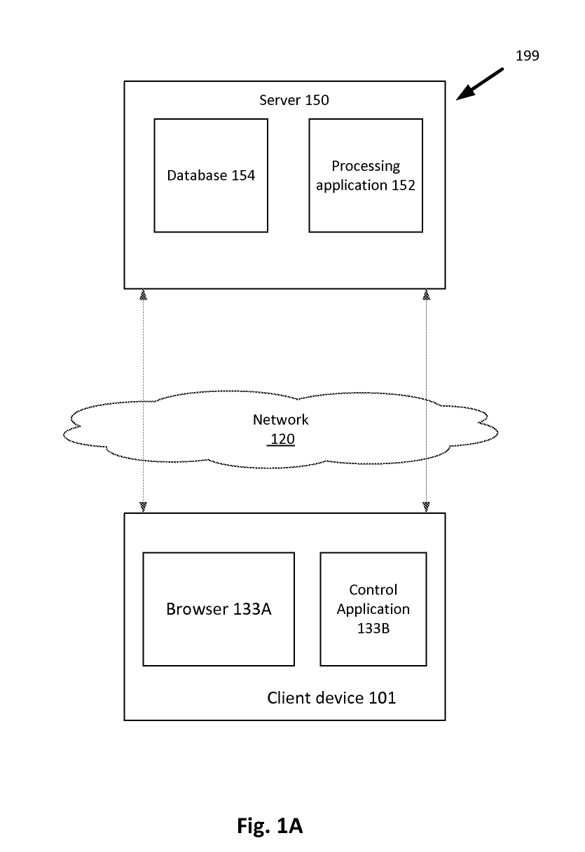

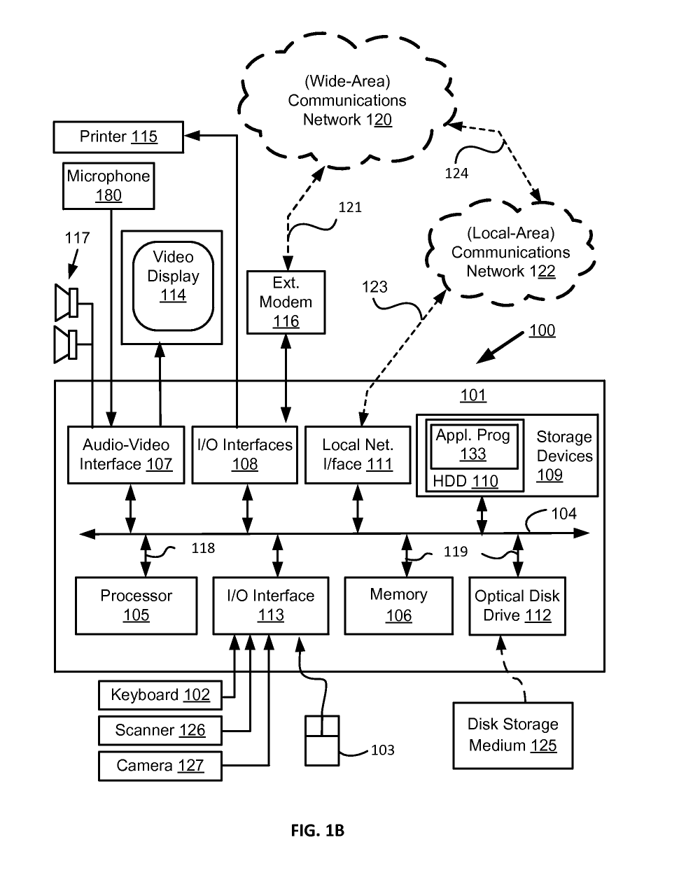

FIG. 1A shows a typical system 199 according to the present disclosure. A user operates a client device 101 to access a server computer 150 via a network 120. The server computer 150 may provide online services which include data storage or security provision, e.g., provision of secure objects via the Covata.io website. The server computer 150 includes a database 154 for storing data and applications associated with use of the service afforded by the server 150. The server computer 150 also includes an application 152 executable on the server computer 150. The application 152 is configured to perform at least a type of processing specific to the service provided by the server computer 150, such as, for example, cryptographic functions.

A browser application 133A is executable on the client device 101 and provides an interface by which the user can access the server computer 150. The browser application 133A may be any type of standard browser application, e.g., Internet Explorer™, Firefox™, Chrome™, Safari™, Opera™ and the like. The network 120 may be a wide-area network or, in some instances, a local-area network, as described hereafter. A control application 133B is executable in association with the browser application 133A. The control application 133B is preferably implemented as a JavaScript application. The control application 133B may be downloaded from the server computer 150 to the client device 101 as described hereafter. The control application 133B executes to control whether data processing is conducted on the client device 101 by the browser application 133A, or on the server computer 150 (by the application 152).

### Computer Description

FIG. 1B depicts a general-purpose computer system 100, upon which the various arrangements described can be practiced.

As seen in FIG. 1B, the computer system 100 includes: the computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1B, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or a like computer systems.

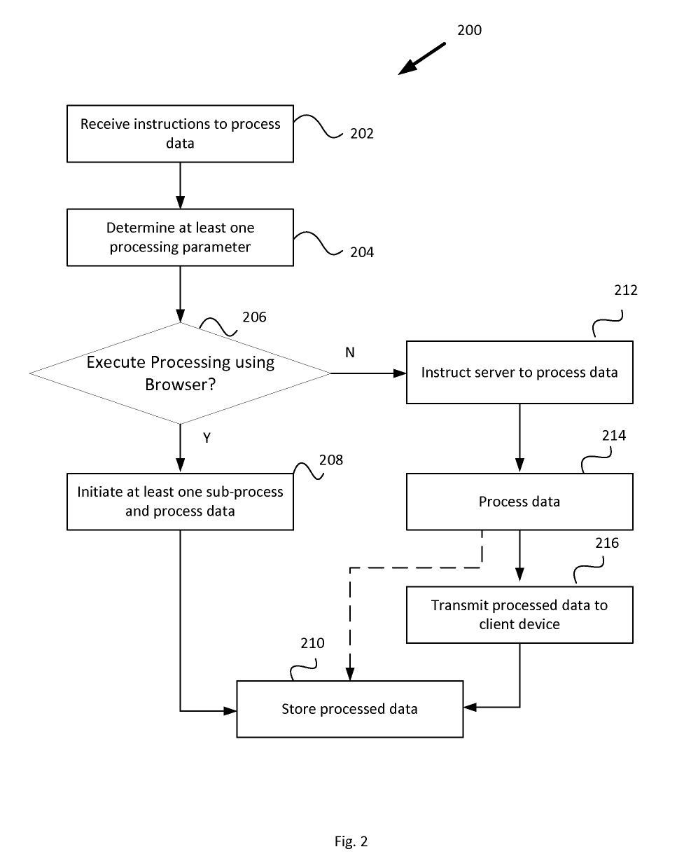

The methods of FIGS. 2-4 may be implemented using the computer system 100 wherein the processes of FIGS. 2-4, to be described, may be implemented as one or more software application programs 133 executable within the computer system 100. In particular, the steps of the methods of FIGS. 2-4 are effected by instructions in the software 133 that are carried out within the computer system 100, e.g., the applications 133A, 133B. The software instructions may be formed as one or more code modules, each for performing one or more particular tasks. The software may also be divided into two separate parts, in which a first part and the corresponding code modules performs the methods disclosed and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for the methods disclosed herein.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for controlling whether data processing is conducted in a browser application.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

In the description hereafter, the module 101 is used in as an example client device 101. However, this description applies equally to other types of client devices. The client device 101 may be any suitable type of client device, including a desktop computer, a tablet computer, a laptop, a notebook computer, a smartphone and the like. The client device 101 may execute appropriate operating systems such as Apple iOS™, Microsoft Windows™, Linux™, Android™ and the like. The operation of such devices is typically similar to that of the client module 101 described in relation to FIG. 1B. The server computer 150 typically operates in the same manner as the client device described in relation to FIG. 1B above.

### Overview of Method

FIG. 2 shows an outline browser method 200 for controlling data processing. The method 200 is controlled by the control application 133B and executed in concert with the browser application 133A on the client device 101. The browser application 133A executes to provide a generic interface by which the client device 101 accesses data from the server computer 150, as described above. The method 200 starts at step 202 where the browser application 133A receives instructions from a user of the client device 101 to process data (e.g., to encrypt a file). Instructions may be given by the user using typical computer inputs to interact with a presentation formed on the display 114 by execution of the browser application 133A, examples of such inputs being the mouse 103, the keyboard 102, etc., or, in some devices, a touch screen. The control application 133B receives an indication of these instructions from the browser. The method 200 then progresses to step 204, where the control application 133B determines at least one processing parameter associated with completing the required processing using the browser application.

The processing parameters typically relate to the size of the data to be processed, the number of jobs currently being processed, and the nature of the processing. One example parameter includes a number of sub-processes or Web Workers required to complete the required processing. Web Workers are a JavaScript technology. A Web Worker is an application program interface (API) or sub-application that is used for spawning background scripts for sub-processes, such as encryption, in a web or browser application, e.g., 133A. Web Workers can operate in parallel with one another using thread-like messaging systems. In the arrangements described herein, a Web Worker normally operates on a single file. Web Workers were developed to improve user experience in browser-side processing. Without use of Web Workers, a heavy computation within a browser application will typically just “hang” without providing the user any feedback to the progress in processing the data. With Web Workers technology, the user can be provided with updates to see that the browser application is working as expected. However, Web Workers technology can be problematic as different browser applications can support a different number of Web Workers—going beyond a corresponding limit can crash the user's browser application. The processing parameters determined by the application 133B in step 204 may include the number of files to be processed and accordingly the number of Web Workers required to complete the processing. The processing parameters must also account of any Web Workers already being executed by the web browser.

Further, complications in browser processing arise due to differing browser application capabilities in handling large data sizes. Specifically, different browser applications can handle different amounts of memory before the browser application will crash. Thus, encryption of a large data file may work for one browser application but may crash another. Accordingly, the control application 133B normally determines the size of the data to be processed at step 204 as a processing parameter.

Another complication in browser processing involves the decryption and then storage of files on a user's local system. A traditional limit of JavaScript APIs is that the user of a client device (or a programmer of the API) has no ability to control the name of a file that is the result of client side processing (e.g., decryption on the client side) when attempting to store processed data on client device 101. Instead, JavaScript APIs only provided a way of creating a file with a random-looking file name, with no ability to control the processed data file type (e.g., “.pdf”, “.jpg”, etc. . . . ). This has a major negative impact from a usability point of view, for example getting a file name like “3F2704E0-4C89-41D3-9A0C-0305E82C3301” rather than “financial_report.pdf.” The consequence of this is that if the user wanted to be able to control the file name of the processed data (e.g., decrypted content), the user could not use client-side JavaScript to do so. Instead, the user would need server side processing or could use a plugin technology such as Flash™ or Silverlight™ executable on the client device 101. The use such technologies further detract from user experience by forcing the user to download and install those technologies onto the client device 101. Technologies such as Flash™ and Silverlight™ may also be prone to security issues that are not desirable to an operator of the server computer 150 or the user of the client device 101. Further, these technologies often require regular updates to address security issues, increasing inconvenience to the user. HTML5 provides a feature, a download attribute of the anchor tag, that can be used to control the file name when processing is happening on the client device 101. The download attribute allows the application 133B to set a separate file download name than the actual link endpoint itself. This feature is not yet supported by all browsers. Support of this feature in the browser application 133A may also be a processing parameter determined at step 204.

The method 200 progresses from step 204 to step 206. At step 206, the control application 133B determines whether the instructed data processing (e.g., encryption) is to be executed by the browser application 133A. The control application 133B is configured to store limits or thresholds for comparison to the processing parameters (as measured in step 204) for determining if data processing to be effectively executed at the browser application 133A.

The control application 133B is configured in this example to store limits to how many Web Workers can be safely handled (irrespective of browser) and what file sizes can be handled (irrespective of browser). That is, the control application 133B is configured to have a “safety threshold” which indicates that processing can be completed without crashing the browser application 133A, whichever browser application is executing on the client device 101. Provided that the required processing falls within this safety threshold, the processing will be entirely done on the client device 101.

As described, the control application 133B is configured to store these values. However, there are alternate ways of providing this information to the client device 101, such as receiving the information from the server computer 150 via an HTTP request. Additionally, an alternate approach to a “safety threshold” is to provide different limits applicable to different browser applications. That is, rather than using one set of limits that is safe for all browser applications, instead use larger limits according to the specific browser application installed on the client device 101 and the capabilities of that browser. The application 133B operates at step 206 to compare the processing parameters to a configuration parameter such as the maximum number of Web Workers in total.

The applicant has conducted a series of tests and determined that a limit of 5 Web Workers and file sizes up to 15 megabytes are preferable safety thresholds usable for current major browser applications. In some implementations, the threshold number of Web Workers could be configured as a higher number than 5. However, this could have a consequence of not supporting all browser version tested. In particular, tests were conducted for the following browser applications:

| Device Type | Browser application | Version |
|---|---|---|
| Macintosh | Chrome | 38 |
| Windows Desktop | FireFox | 17 |
| Macintosh | FireFox | 35 |
| Windows Desktop | Internet Explorer | 10 |
| Windows Desktop | Internet Explorer | 11 |
| Macintosh | Safari | 7 |

This means that these major browser applications can handle concurrent processing operations involving five 15 MB files.

At step 206, the control application 133B compares the processing parameters determined at step 204 to the stored predetermined thresholds. If the comparison indicates that processing is to be executed using the browser (e.g., measured parameters are below the safety threshold), the method 200 proceeds to step 208, whereupon the control application 133B instructs the browser application 133A to initiate at least one sub-process, i.e., Web Worker and process the data. Once completed, the method 200 proceeds to step 210 and the processed data is stored on the memory 106 of the client device 101 or on a memory of the server computer 150. In some instances, the processed data is stored on a temporary memory of the client device 101. In other instances, the processed data may be stored on a hard drive or a removable disk drive of the client device 101. In other implementations, the on a memory of some other device networkable to the client device 101 or the server computer 150.

If at step 206, the application 133B determines that processing is not to be executed using the browser application 133A, this is handed over to the server computer 150. In the examples provided, a single server computer 150 is used. However, in other embodiments, a number of server computers may be used, or the server to which processing is done may be separate to the server computer 150 being accessed by the browser application for web browsing.

The method 200 progresses to step 212 and instructs the server to process the data. Data may be transmitted to the server computer 150 in a “chunked” manner. “Chunked” uploading is an uploading technique used in HTML which breaks a large file into small chunks. These pieces or chunks may be uploaded to the server computer 150 one-by-one. If an upload fails, transmission need only resume from the last successful chunk.

The data is processed at the server computer 150 in step 214, normally by execution of the processing application 152. Once processing is complete, the method 200 progresses to step 216 and the processed (e.g., encrypted) data is transmitted to the client device 101 and stored thereon at step 210. In other implementations, the encrypted data may be stored on the client device 101 or the server computer 150. In instances where the encrypted data is stored on the server computer 150, the method 200 progresses from step 214 to step 210, as indicated by a dashed-line arrow in FIG. 2.

Transmission of data between the client device 101 and the server computer 150 at steps 212 and 216 may be by Secure Sockets Layer (SSL) whether the data is encrypted or not at that stage.

In other implementations (not shown), at step 206, in determining that processing is not to be executed at the browser, the control application 133B may determine that the data processing is to be split or distributed between the browser application 133A and the server computer 133B. Such a determination is also made with respect to the limits or thresholds of the control application 1336. For example, if the required data processing requires 5 Web Workers, the control application 133B, upon determining that 3 Web Workers are currently executing on the client device 101, may determine that the browser application 133A is to partially execute data processing by executing 2 Web Workers (implemented similarly to step 208). The data processing is distributed or split such that the server computer 150 executes the remainder of the data processing (and the browser application 133A does not need to execute a further 3 Web Workers), implemented similarly to steps 212 and 214.

### Encryption Example

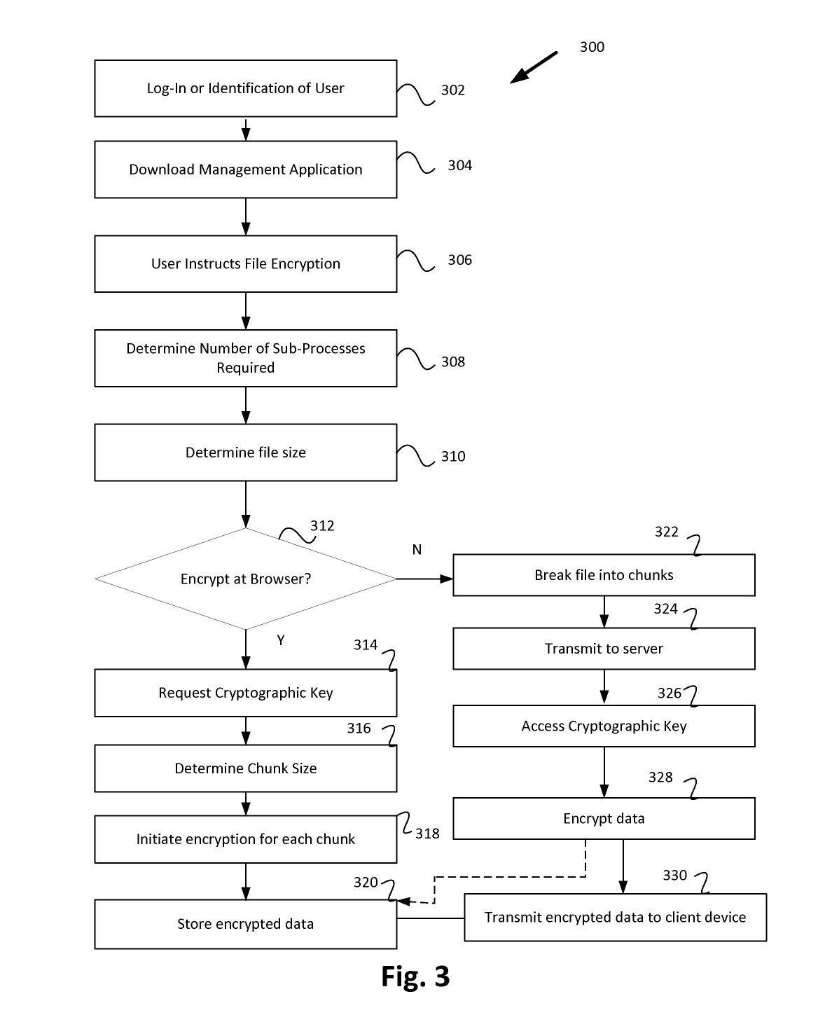

FIG. 3 shows an example browser system relating to encryption of data. In this example, the server computer 150 provides a key for encryption, similar to the Covata™ system. Covata™ provide secure data solutions for a variety of industrial applications, such as for cloud computing, healthcare and mobile solutions. Some example solutions provided by Covata™ are described in Australian Patent No. 2008341026. FIG. 3 provides a sample method involving upload of a selected file or data.

A method 300 begins at step 302 when the user logs in or identifies themselves to the server computer 150 using the client device 101 executing the browser application 133A. Log in or identification to the server application 150 may be via normal means such as by entering a username and password. In other embodiments, establishing communication between the client device 101 and the server computer 150 may be sufficient—login or identification may not be required. The server application 150 may also provide a token (to be stored by the application 133B) for identification of the user.

The method 300 proceeds to step 304 wherein the control application 133B is downloaded to the client device 101 from the server computer 150 via the network 120. The control application is a JavaScript application executable in association with the browser application 133A. The control application 1336 typically executes persistently in association with the browser application

At step 306, the user instructs the browser application 133A to encrypt a set of selected files or data using one or more inputs of the client device 101. The file is normally read using functions from the HTML5 File API. The control application 133AB reads the file in as a JavaScript blob, which represents raw bytes of the selected file. This step corresponds to step 202 of FIG. 2. The control application 133B receives this instruction. Upon this instruction being received, the system 300 moves to step 308. At step 308, the control application 133B determines the number of sub-processes currently running (i.e., the number of Web Workers currently running) to encrypt the selected document. Once the number of sub-processes had been determined, the method proceeds to step 310. At step 310, the control application determines the size of the selected file or data. Steps 308 and 310 relate to step 204 of FIG. 2.

The method 300 proceeds to step 312. At step 312, the control application 133B determines if processing should occur at the browser application 133A or the server computer 150. At step 312, the parameters determined in steps 308 and 310 are compared to stored thresholds by the control application 133B. For example, the determined parameters are compared to a maximum of 5 Web Workers and a maximum file size of 15 MB. Example HTML code for this decision is:

if (uploadsInProgress > maxAllowedUploads ∥

fileSize > maxAllowedFileSize) {

//hand off the file to the server for processing

} else {

//encrypt the file in the browser

}

The step 312 corresponds to step 206 of FIG. 2.

If the threshold requirements are met, control application 133B determines that the encryption is to occur at the browser application at step 312, and the method 300 proceeds to step 314. At step 314 the control application 133B requests a cryptographic key from the server application 152. In the Covata™ system, this is obtaining a cryptographic key and initialization vector (iv) from the Covata™ Access Service. In other implementations (not shown), the cryptographic key may be generated by the browser application 133A, or some other application executable on the client device 101.

Upon receipt of the cryptographic key, the control application 133B proceeds to step 316. At step 316 the size of chunks into which the selected data file is to broken up is determined, e.g., into less than 5 MB, by the control application 133B. In some instances, e.g., for a file of 5 MB or less, step 316 may be bypassed (not shown).

Once step 316 is complete, the method 300 proceeds to step 318. At step 318, the control application 133B initiates or spawns a Web Worker and passes the file to the Web Worker for encryption via the web worker's ‘postMessage’ mechanism. The ‘postMessage’ mechanism is how messages are passed between the worker process and the main user interface (UI) thread. Example code for initiating a Web Worker is:

var worker = new Worker(‘../path/to/fileCryptoWorker.js’)
worker.postMessage({

key: key,
iv : iv,
file: file,

chunkSize: 5242880,

progressive: true

});

In the call to ‘postMessage’ the chunk size determined in step 316 is also included. This is used if the ‘progressive’ flag is set to ‘true’ and is used to break the file down into chunks if the selected is larger than 5 MB. Performing encryption (or decryption or other types of processing) in a progressive manner helps to manage memory when dealing with large files. As each chunk is processed (encrypted/decrypted and hashed) the chunk can be disposed of in order to limit the memory used in the browser application 133A. Steps 314-318 relate to step 208 of FIG. 2. The encrypted data is then stored on the client device 101 or the server computer 150 at step 320 (similarly to step 210 of FIG. 2) and the method 300 ends.

If at step 312, the control application 1336 determines that encryption is not to be executed at the browser application 133A, the method 300 proceeds to step 322. At step 322, the control application breaks the selected file into chunks of suitable size for transmission. The method then progresses to step 324, wherein the file chunks are transmitted to the server computer 150. Transmission to the server computer 150 is normally completed using SSL to prevent a security breach of the unencrypted data. Steps 322-326 relate to step 212 of FIG. 2. The control application 133B may also provide additional information to the server computer 150 that may be necessary to complete the request. For example, in the Covata application, the server needs to have access to the user's token for a number of purposes including but not limited to identifying the user.

The method 300 continues to step 326, wherein the server application 152 accesses an encryption key from the database 154 of the server computer 150. In other implementations, the encryption key may be stored elsewhere such as on the client device 101, or another device in communication with the server computer 150. The method 300 then continues to step 328, whereupon the selected data or file is encrypted in the normal manner (similar to step 214 of FIG. 2). In the example shown in FIG. 3, once encryption is complete, the method 300 proceeds to step 330. At step 330, the server application transmits the encrypted data to the client device 101 (similarly to step 216 of FIG. 2). The transmitted encrypted data is stored on the client device 101 at step 320. In other implementations, the encrypted data may be stored on the server computer 150 or some other device in communication with the server computer 150. For example, the method 300 may progress from step 328 to step 320 as shown by a dashed-line arrow in FIG. 3.

The reason the control application 133B is configured not to direct progressive encryption of large files (larger than maxAllowedFileSize) in the browser application 133A, but instead hands the file to the server computer 150, is a simple matter of performance. Encrypting an entire file in one go is often much faster than breaking that file up into chunks, encrypting each chunk and then finalizing the encryption process. For files that are extremely large, the progressive encryption would result in unacceptable delay to the user experience: for example, the user would not be able to logout until the encryption is completed.

### Decryption Example

FIG. 4 shows an example browser system relating to decryption of data. In this example, the server computer 150 provides a key for decryption, similar to the Covata™ system. The user may identify themselves using a log-in similar to that described in relation to step 302 of FIG. 3, and the control application 133B may accordingly be downloaded to the client device 101 as per step 304 of FIG. 3. For ease of reference, these steps have been omitted from FIG. 4. The control application 133B is executing in concert with the browser application 133A on the client device 101 in a method 400 of FIG. 4. FIG. 4 provides a sample method involving download of a selected file or data.

The method 400 begins at step 402 where the user of the client device 101 provides instructions to the browser application to decrypt a selected file. The control application 133B receives this instruction. Step 402 corresponds to step 202 of FIG. 2.

The method 400 continues to step 404. In the example of FIG. 4, the selected encrypted file is stored at the server computer 150, similarly to the Covata™ system. In other implementations, the selected encrypted file may be stored on the client device 101, to some other computer. At step 404, the control application requests information regarding the selected file size and MIME (Multipurpose Internet Mail Extensions) type of the selected filed form the server computer 150. The MIME type is a standard identifier used on the Internet to indicate the type of data that a file contains. In other implementations, step 404 may be excluded. The request may be transmitted securely using SSL or via standard internet communication. The method 400 progresses to step 406, wherein the server computer 150 transmits the file size and MIME type to the client device 101. This information is processed by the control application 133B.

The method 400 then progresses to step 408. At step 408, the control application 133B executes to determine the number of sub-processes or Web Workers required to perform the instructed decryption. This is similar to step 308 of FIG. 3. The method 400 continues to step 410. At step 4110, the control application 133B determines if the download attribute of HTML anchor tags are supported by the browser application 133A. File size, the number of sub-processes required, and support of the download attribute of HTML anchor tags are all processing parameters for decryption of the selected file. Steps 404 through 410 relate to step 204 of FIG. 2.

Returning to FIG. 4, the method 400 proceeds from step 410 to step 412. At step 412, the control application 133B determines whether the selected file should be decrypted at the browser application 133A of the client device 101, or at the server computer 150. This is similar to step 206 of FIG. 2. At step 412, the parameters determined in steps 406 to 410 are compared to stored thresholds. For example, the determined parameters of step 406 and 408 are compared to a maximum of 5 web workers and a maximum file size of 15 MB respectively. The parameter determined in step 410, support of the download attribute of HTML anchor tags, may be compared to a requirement for decryption at the browser application 133A. A partial example HTML code for this decision is:

if (downloadsInProgress < maxAllowedDownloads &&

fileSize < maxAllowedFileSize &&
browserSupportsDownloadAttribute) {
//decrypt locally

} else {

//decrypt on server and then hand decrypted file to the browser

to download.

}

This step is very similar to the step for determining whether to execute encryption at step 312 of FIG. 3. However, in this instance, the control application 133B also needs to check whether the browser application 133A supports the aforementioned download attribute of the HTML anchor tag. Step 412 is similar to step 206 of FIG. 2.

If at step 412, the control application 133B determines that decryption is to be executed at the browser application 133A, the method 400 proceeds to step 414. At step 414 the control application 133B requests the selected file and the associated cryptographic key from the database 154 of the server computer 150. The request may be made by an AJAX protocol request. The selected file and cryptographic key are received by the client device 101 from the server computer 150, and the method 400 continues to step 416. In alternate implementations (not shown), the cryptographic key may be stored on a device other than the server computer 150 such as another device networkable to the server computer 150 and/or the client device 101.

At step 416, the size of chunks into which the selected data file is to be divided is determined, e.g., into less than 5 MB, by the control application 133B. In some instances, e.g., for a file of 5 MB or less, step 416 may be bypassed (not shown). The method 400 then proceeds to step 418. At step 418 the control application 133B initiates or spawns a Web Worker and passes the file and the key to the Web Worker for decryption via the web worker's ‘postMessage’ mechanism. The decrypted file or data is sent back to the UI thread. An example HTML instruction is:

var worker = new Worker(‘../path/to/fileCryptoWorker.js’)
worker.postMessage({

key: key,
encrypted : file

});

In the Web Worker process:

var decrypted = CryptoJS.AES.decrypt(

encrypted,
key, {

iv: iv

});

self.postMessage({

decrypted: decrypted

});

Step 414-420 relate to step 208 of FIG. 2.

Returning to FIG. 4, the method 400 continues to step 420, in which the decrypted file is wrapped in a Blob, a HTML interface for raw data. Step 420 is executed by the browser application 133A. Sample HTML for this step is:

var blob=new Blob([file], {type: mimeType});

Step 420 is necessary in this example as this is how the control application 133B obtains a URL which can be set in the anchor tag the application 133B will construct, as discussed below.

The method 400 progresses to step 422. At step 422, the control application 133B creates an anchor tag for the decrypted data. This step involves creating a URL:

var url=window.createObjectURL(blob);

In the above code, the control application 133B creates a URL using the HTML5. The control application 133B then creates an html anchor tag, the method 400 progresses to step 424, at which the control application 133B sets the file name in the download attribute and URL in the href attribute of the anchor tag from step 422. The decrypted file is then stored on the client device 101 by adding the anchor tag to the URL and initiating a simulation of a download. This results in presentation of a link on the display 144 by the browser application. The user of the client device can select (e.g., using the mouse 103) the link to complete the download. Sample command for this step is as follows:

$(“<a>”)

.attr(“download”, fileName)
.attr(“href”, url)
.appendTo(“body”)
.click( )
.remove( );

Step 424 relates to step 210 of FIG. 2.

Unlike the method 300 (FIG. 3) of performing encryption, the control application 133B is not configured to progressively decrypt the selected file. This is because when the control application 133B encrypted the selected file in FIG. 3, the control application 133AB read the file in as a JavaScript ArrayBuffer, which represents raw bytes of the selected file.

Using a JavaScript ArrayBuffer is widely accepted as the recommended approach in terms of browser compatibility, efficiency and API stability. In other embodiments, reading the file in as a string by the control application 133B is possible, but the API call to do this is marked for deprecation. The ArrayBuffer can have a large memory footprint that also involves more heavyweight computation when passed to cryptographic functions.

Upon receiving instructions related to a download, the control application 133B receives the file as a Base64 encoded string from the server. This has a much lighter memory footprint than raw bytes and cryptographic functions handle strings much more efficiently.

Returning to step 412 of FIG. 4, if the control application 133B determines that the decryption is not to be executed at the browser, the method 400 progresses to step 426. At step 426, the control application 133B instructs the server application 152 to decrypt the file and provide the decrypted file to the client device 101. The method continues to step 428, wherein the server application 152 accesses the file and the relevant cryptographic key. The server application 152 then decrypts the file using the key as shown at step 430. The method 400 continues to step 432, at which the server application 152 transmits the decrypted file to the client device 101. As the file is decrypted, the transmission of step 432 preferably uses a secure protocol such as SSL. The method 400 continues to step 424. At step 424, the decrypted file is saved in the normal download manner by the control application 133B.

In the examples provided above, ordering of steps may be varies, e.g., the steps 308-310 and the steps 404-410 if FIGS. 3 and 4 respectively may be varied.

### Data Flow

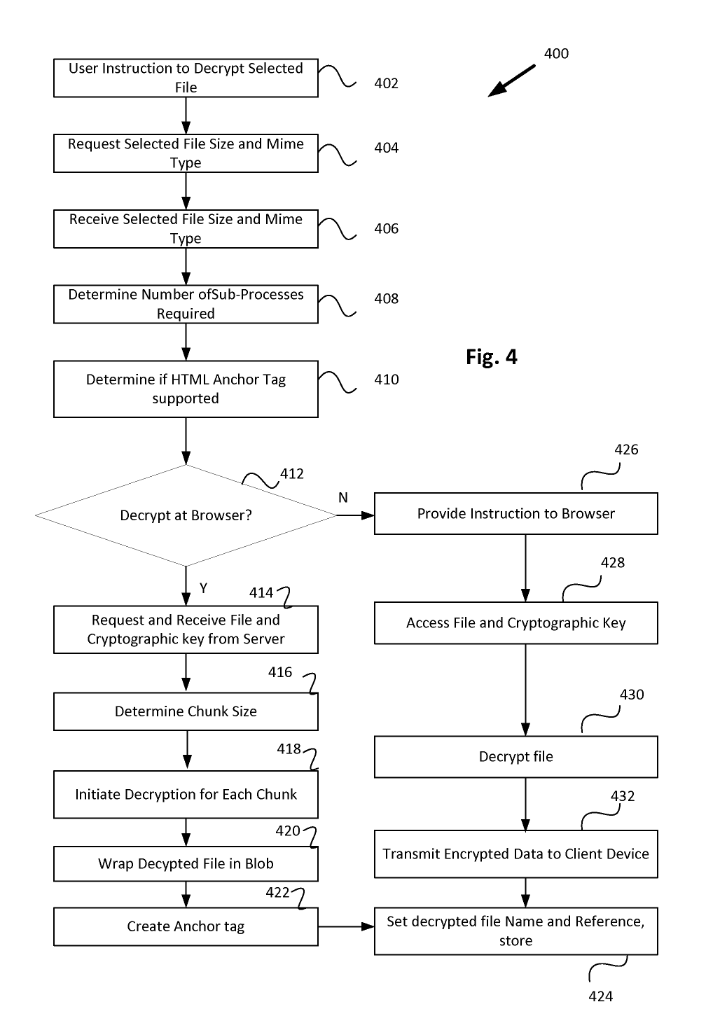

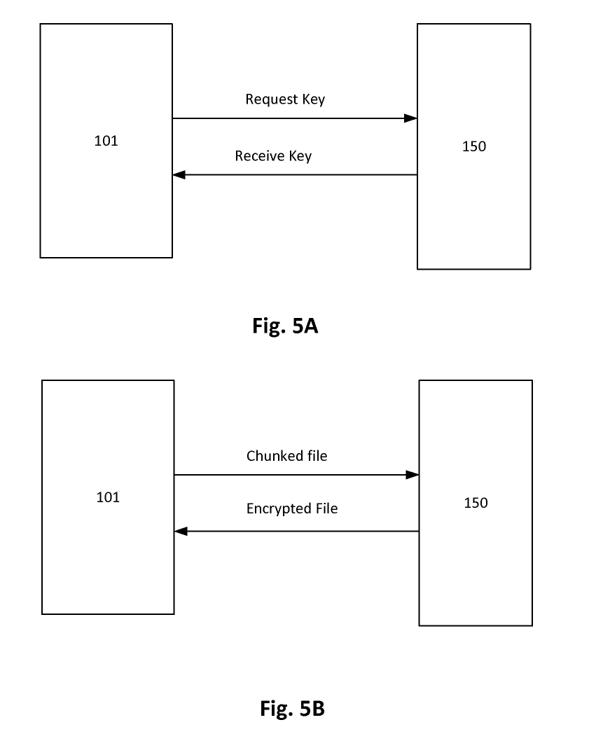

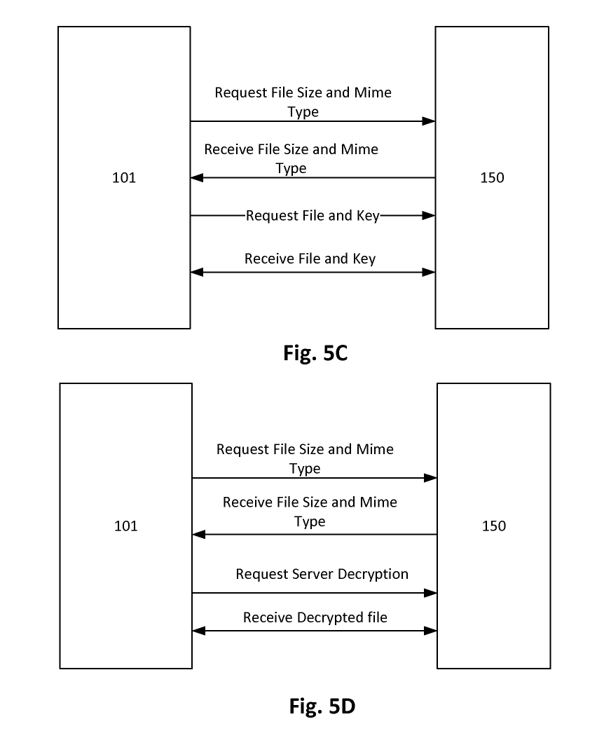

FIGS. 5A-5D show dataflow for a number scenarios described in FIGS. 3 and 4 hereinbefore. FIG. 5A shows data flow between the client device 101 and the server computer 150 where data encryption is performed by the browser application (step 312 is ‘Y’ in FIG. 3). In this instance communication relates to requesting and reception of the cryptographic key by the control application 133B (step 314).

FIG. 5B relates to a scenario where encryption is performed by the server computer 150 (step 312 is ‘N’ in FIG. 3), and where the encrypted data is stored on the client device 101 (the method 200 progresses from step 214 to step 216). Data flow in this instance includes upload of the chunked file (step 324) to the server computer 150. The client device 101 receives the encrypted file from the server computer 150 (step 330).

FIG. 5C shows data flow between the client device 101 and the server computer 150 where data is to be decrypted by the browser application (step 412 is ‘Y’ in FIG. 4). The client device transmits a request for file size and MIME type (step 404) to the server computer 150 and receives the file size and MIME type (step 406) of FIG. 4. Further, the client device 101 requests and receives the file and associated cryptographic key from the server computer 150 (step 414 of FIG. 4).

FIG. 5C shows data flow between the client device 101 and the server computer 150 where data is to be decrypted by the browser application (step 412 is ‘N’ in FIG. 4). The client device transmits a request for file size and, if appropriate, MIME type (step 404) to the server computer 150 and receives the file size and MIME type (step 406) of FIG. 4. Further, the client device 101 transmits a request for server decryption (step 426) and, once decryption is complete, receives the decrypted file (step 432).

### Advantages

The solution described herein provides a satisfactory user experience for computation-intensive data processing, irrespective of the user's type of browser application 133A. The browser system and method described herein are particularly suited for cryptography (encryption/decryption) uses. Execution of encryption/decryption in a web browser is rather than on a server is firstly a desirable feature because computational load is removed from the server, which allows the server to support more users. Performing encryption processes in a browser application is additionally desirable as the encryption tasks are executed “end-to-end”: i.e., a file is encrypted at the original user's computer and decrypted at the client device rather than transmitted in unencrypted form to a server computer.

Some examples of browser encryption and decryption such as Mega™ have previously been provided. However, such applications have experienced a number of issues, including difficulty supporting a range of major browser versions and providing the frustrating or bad user experience. The present disclosure provides a solution which is supported by a large set of current major browsers, while providing a positive user experience. The present application provides a positive user experience by processing data on client side where possible, but falling back to server-side processing when client-side processing is problematic, in a manner transparent to a user.

However, the processing data in a browser application rather than on a server is a desirable feature as computation or load is removed from the server. This allows the server to support more users. Further, processing data in a browser application provides a security feature as the processing is provided at the original user or client's computer and is not transmitted in a process form.

### INDUSTRIAL APPLICABILITY

The arrangements described are applicable to the computer and data processing industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A computer-implementable method for controlling data processing by a browser application executable on a client device, the method comprising:
receiving instructions at the client device to process data;
determining at least one processing parameter associated with processing of the data by the browser application;
determining whether the instructed processing is to be executed by the browser application based upon the determined at least one processing parameter;
initiating at least one browser sub-process to process the data where processing is determined is to be executed by the browser application;
instructing a server application executable on a server computer in communication with the client device to process the data where processing is determined not to be executed by the browser application; and
storing the processed data at one of the client device and the server computer.

2. The method according to claim 1, wherein the steps of determining and initiating are performed by a control application executable on the client device.

3. The method according to claim 2, wherein the control application is a JavaScript application.

4. The method according to claim 3, wherein the JavaScript application is provided to the client device, upon which the control and browser applications execute, by the server application executable on the server computer.

5. The method according to claim 1, wherein the at least one sub-process is a Web Worker.

6. The method according to claim 1, wherein the at least one processing parameter includes at least one of a number of sub-processes required, a size of the data, and support of the anchor tag of the HTML download attribute by the browser application.

7. The method according to claim 1, wherein the determination of whether the instructed processing is to be executed via the browser application comprises comparing the determined at least one processing parameters to at least one predetermined threshold.

8. The method according to claim 1, wherein determining whether the instructed processing is to be executed by the browser application comprises determining whether the instructed processing is to be distributed between the server computer and the browser.

9. A system for controlling data processing by a browser application, the system comprising:
a server computer; and
a client device in communication with the server computer; the browser application being executable on the client device, the client device being configured to:
receive instructions to process data;
determine at least one processing parameter associated with processing of the data by the browser application;
determine whether the instructed processing is to be executed by the browser application based upon the determined at least one processing parameter;
initiate at least one browser sub-process to process the data where processing is determined is to be executed by the browser application; and
instruct the server application executable on a server computer to process the data where processing is determined not to be executed by the browser application; and store the processed data on one of the client device and the server computer.

10. A computer-implementable method for controlling data cryptographic processing by a browser application executable on a client device, the method comprising:
receiving instructions at the client device to perform cryptographic processing on data;
determining at least one processing parameter associated with cryptographic processing of the data by the browser application;
determining whether the instructed cryptographic processing is to be executed by the browser application based upon the determined at least one processing parameter;
obtaining a cryptographic key and initiating at least one browser sub-process to conduct the cryptographic processing of the data where cryptographic processing is determined is to be executed by the browser application;
instructing a server application executable on a server computer in communication with the client device to retrieve a cryptographic key and conduct the cryptographic processing of the data where cryptographic processing is determined not to be executed by the browser application; and
storing the processed data at one of the client device and the server computer.

11. The method of claim 10, wherein the cryptographic processing comprises one of encrypting and decrypting the data.

12. The method of claim 10, wherein, when the cryptographic processing comprises encrypting the data, obtaining the cryptographic key comprises generating the cryptographic key on one of the server computer and the client device.

13. The method of claim 10, wherein the cryptographic key is stored on one of the client device and the server computer.
